(19) United States
(12) Patent Application Publication
(10) Pub. No.: US 2011/0111129 A1
(43) Pub. Date: May 12, 2011

(54) METHOD FOR FABRICATING CADMIUM SULFIDE THIN FILM

(75) Inventor: Uen-Ren Chen, Taoyuan (TW)

(73) Assignee: JENN FENG NEW ENERGY CO., LTD., Taoyuan (TW)

(21) Appl. No.: 12/615,570

(22) Filed: Nov. 10, 2009

(51) Int. Cl. B05D 1/18; B05D 3/00

(52) U.S. Cl. 427/372.2

(57) ABSTRACT

A method for fabricating a cadmium sulfide thin film, in which the chemical bath including the sulfur-containing compounds and the cadmium-containing compounds is adjusted to alkaline by adding aqueous ammonia, followed by adding the buffer salts while stirring and heating, and then the glass substrate is immersed in the chemical bath such that when the immersing time is increased, the thickness of cadmium sulfide thin film will be increased, and the cadmium sulfide thin film obtained does not have a dual structure, and thereby the obtained cadmium sulfide thin film can have excellent adhesion to the glass substrate, and thereby the quality of cadmium sulfide thin film can be improved.

### BACKGROUND OF THE INVENTION

1. Field of the Invention

The present invention relates to a method for fabricating a cadmium sulfide (CdS) thin film, and more particularly to a chemical bath deposition for fabricating the cadmium sulfide thin film.

2. The Prior Arts

Cadmium sulfide is a II-VI semiconductor material with wide band gap (Eg=2.26˜2.5 eV). Cadmium sulfide is mainly applied in the solar cells, the light emitting diodes, the photoconductor sensors, the photocatalysts and the other photoelectric devices. The well-known methods for fabricating a cadmium sulfide thin film are the chemical bath deposition method, the microwave-assisted chemical bath deposition method, the vacuum evaporation method, the sputtering method, the chemical vapor deposition method, and the spray pyrolysis method.

The chemical bath deposition method comprises the steps of: (1) immersing the glass substrate in a diluted solution containing cadmium ions and sulfide ions; and (2) automatically depositing a cadmium sulfide thin film on the glass substrate. The advantages of chemical bath deposition method are that the mass production is easily available at lower costs, and the process is simple to use.

According, the present invention provides a fabricating method to precisely control the cadmium sulfide thin film, by which a high quality cadmium sulfide thin film with uniform thickness can be obtained, and the obtained cadmium sulfide thin film has excellent adhesion to the glass substrate.

### SUMMARY OF THE INVENTION

The objective of the present invention is to provide a method for fabricating a cadmium sulfide thin film, in which a cadmium sulfide thin film is fabricated by using a chemical bath deposition method. According to the method of the present invention, the chemical bath including the sulfur-containing compounds and the cadmium-containing compounds is adjusted to alkaline by adding aqueous ammonia, followed by adding the buffer salts while stirring and heating, and then the glass substrate is immersed in the chemical bath such that when the immersing time is increased, the thickness of cadmium sulfide thin film will be increased, and the cadmium sulfide thin film obtained does not have a dual structure, and thereby the obtained cadmium sulfide thin film can have excellent adhesion to the glass substrate, and thereby the quality of cadmium sulfide thin film is improved. The amount of the cadmium ions contained in the chemical bath is 10 to 500 times of the amount of cadmium ions contained in the cadmium sulfide thin film, and the amount of the sulfide ions contained in the chemical bath is 5 to 100 times of the amount of sulfide ions contained in the cadmium sulfide thin film. The concentration of aqueous ammonia is 20% to 30%. The preferred pH value of chemical bath is 8 to 11, the preferred heating temperature is 60 to 90° C., and the preferred immersing time is 5 to 60 minutes.

Therefore, the cadmium sulfide thin film with a thickness of 10 to 1000 nm can be obtained, and the obtained cadmium sulfide thin film has excellent adhesion to the glass substrate.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a flow chart illustrating a method for fabricating the cadmium sulfide thin film of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

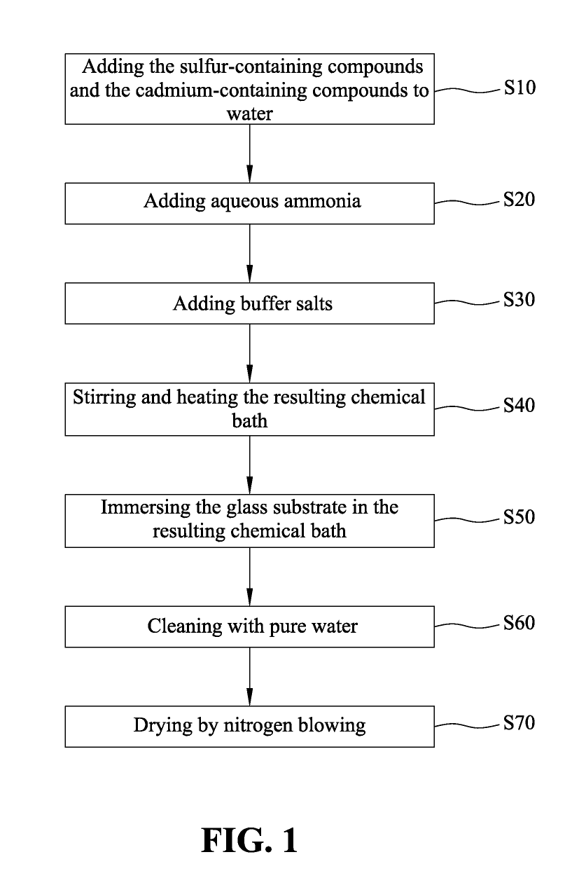

Referring to FIG. 1, the flow chart illustrating the method for fabricating the cadmium sulfide thin film of the present invention. As shown in FIG. 1, in Step 10, the sulfur-containing compounds and the cadmium-containing compounds are added to water. The preferred cadmium-containing compounds can be at least one of cadmium sulfate, cadmium acetate, cadmium nitrate and cadmium chloride. The preferred sulfur-containing compounds can be at least one of thiourea, sodium sulfide, and thioacetamide. The amount of the cadmium ions contained in the chemical bath is 10 to 500 times of the amount of cadmium ions contained in the cadmium sulfide thin film, and the amount of the sulfide ions contained in the chemical bath is 5 to 100 times of the amount of sulfide ions contained in the cadmium sulfide thin film. Then, in Step 20, the chemical bath including the sulfur-containing compounds and the cadmium-containing compounds is adjusted to alkaline by adding aqueous ammonia. The preferred pH value is 8 to 11. Then, in Step 30, the buffer salts are added to the resulting chemical bath to improve the quality of coating. The preferred buffer salts are at least one of ammonium chloride, ammonium acetate, ammonium nitrate and ammonium sulfate. Then, in Step 40, the resulting chemical bath is stirred and heated. The preferred heating temperature is 60 to 90° C. Then, in Step 50, the glass substrate is immersed in the chemical bath for 5 to 60 minutes to form a cadmium sulfide thin film on the glass substrate. Then, in Step 60, the glass substrate with the cadmium sulfide thin film coated thereon is cleaned by water to remove the residual impurities and chemicals. Finally, in Step 70, the glass substrate with the cadmium sulfide thin film coated thereon is dried by nitrogen blowing. Consequently, the cadmium sulfide thin film coated on the glass substrate of the present invention is obtained.

The water used in Steps 10 and 60 can be the deionized water. The concentration of the aqueous ammonia used in Step 20 can be 20% to 30%. In the present invention, the cadmium sulfide thin film with a thickness of 10 to 1000 nm can be obtained, and the obtained cadmium sulfide thin film has excellent adhesion to the glass substrate.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for fabricating a cadmium sulfide thin film on a glass substrate, comprising the steps of:
adding a sulfur-containing compound and a cadmium-containing compound to water to form a chemical bath;
adding aqueous ammonia to the chemical bath to adjust a pH value thereof;
adding a buffer salt to the resulting chemical bath while stirring and heating;
immersing a glass substrate in the resulting chemical bath to coat a cadmium sulfide thin film on the glass substrate;
cleaning the glass substrate with the cadmium sulfide thin film coated thereon with water; and
drying the glass substrate with the cadmium sulfide thin film coated thereon by nitrogen blowing.

2. The method according to claim 1, wherein the cadmium-containing compound is at least one of cadmium sulfate, cadmium acetate, cadmium nitrate and cadmium chloride.

3. The method according to claim 1, wherein the sulfur-containing compound is at least one of one of thiourea, sodium sulfide, and thioacetamide.

4. The method according to claim 1, wherein the water is deionized water.

5. The method according to claim 1, wherein a concentration of the aqueous ammonia is 20% to 30%.

6. The method according to claim 1, wherein the pH value of the chemical bath is adjusted to 8 to 11.

7. The method according to claim 1, wherein the buffer salt is at least one of ammonium chloride, ammonium acetate, ammonium nitrate, and ammonium sulfate.

8. The method according to claim 1, wherein the heating temperature is 60 to 90° C.

9. The method according to claim 1, wherein the immersing time is 5 to 60 minutes.

10. The method according to claim 1, wherein thickness of the cadmium sulfide thin film is 10 to 1000 nm.

11. The method according to claim 1, wherein a amount of the cadmium ions contained in the chemical bath is 10 to 500 times of a amount of the cadmium ions contained in the cadmium sulfide thin film, and a amount of the sulfide ions contained in the chemical bath is 5 to 100 times of a amount of the sulfide ions contained in the cadmium sulfide thin film.
